(19) United States
(12) Patent Application Publication
(10) Pub. No.: US 2025/0363346 A1
(43) Pub. Date: Nov. 27, 2025

(54) TRAINING METHODS AND APPARATUSES FOR GRAPH NEURAL NETWORK CONSIDERING PRIVACY PROTECTION AND FAIRNESS

(71) Applicant: ALIPAY (HANGZHOU) INFORMATION TECHNOLOGY CO., LTD., Hangzhou (CN)

(72) Inventors: Wenbiao ZHAO, Scarsdale, NY (US); Ruofan WU, Hangzhou (CN)

(21) Appl. No.: 18/872,377

(22) PCT Filed: Aug. 9, 2023
(86) PCT No.: PCT/CN2023/111948

§ 371 Date: Dec. 6, 2024

(30) Foreign Application Priority Data
Nov. 29, 2022 (CN) 202211507949.1

(51) Int. Cl. G06N 3/08; G06N 3/042

(52) U.S. Cl. CPC G06N 3/08; G06N 3/042

(57) ABSTRACT

Embodiments of this specification provide training methods and apparatuses for a graph neural network considering privacy protection and fairness. The method includes: performing representation aggregation on nodes corresponding to N target users in a user relationship network graph by using the graph neural network, to obtain user representations of the N target users; determining a predicted loss corresponding to each target user based on at least a user representation of each target user by using a predetermined loss function related to a target service; determining a weight value corresponding to each target user based on each predicted loss, so that a larger predicted loss indicates a larger weight value of a corresponding target user; determining a total predicted loss based on the predicted loss and the weight value of each target user; and adjusting parameters of the graph neural network with an objective of minimizing the total predicted loss.

This specification claims priority to Chinese Patent Application No. 202211507949.1, filed with the China National Intellectual Property Administration on Nov. 29, 2022 and entitled “TRAINING METHODS AND APPARATUSES FOR GRAPH NEURAL NETWORK CONSIDERING PRIVACY PROTECTION AND FAIRNESS”, which is incorporated here by reference in its entirety.

### TECHNICAL FIELD

This specification relates to the field of graph neural network technologies, and in particular, to training methods and apparatuses for a graph neural network considering privacy protection and fairness.

### BACKGROUND

Trustworthy AI is an important topic in the development of current machine learning models. As a capability of the model gradually increases and a data volume further increases, an important branch of fairness in trustworthy AI emerges to prevent discrimination against a vulnerable group with a small proportion in a learning process of the model.

Currently, in some of methods for solving a fairness problem of the machine learning model (for example, a graph neural network), some attribute features (for example, gender and age) of a person need to be considered, to train a graph neural network (namely, a fair graph neural network) that has fairness for these attribute features. These attribute features are usually characterized by privacy, and are prone to cause leakage of privacy data of the person. How to provide a training method for a graph neural network considering privacy protection and fairness becomes a problem urgently to be solved.

### SUMMARY

One or more embodiments of this specification provide training methods and apparatuses for a graph neural network considering privacy protection and fairness, to obtain a graph neural network considering privacy protection and fairness through training.

According to a first aspect, a training method for a graph neural network considering privacy protection and fairness is provided. The method includes:
performing representation aggregation on nodes corresponding to N target users in a user relationship network graph by using the graph neural network, to obtain user representations of the N target users;
determining a predicted loss corresponding to each target user based on at least a user representation of each target user by using a predetermined loss function related to a target service;
determining a weight value corresponding to each target user based on each predicted loss, so that a larger predicted loss indicates a larger weight value of a corresponding target user;
determining a total predicted loss based on the predicted loss and the weight value of each target user; and
adjusting parameters of the graph neural network with an objective of minimizing the total predicted loss.

According to a second aspect, a training apparatus for a graph neural network considering privacy protection and fairness is provided. The apparatus includes:
an aggregation module, configured to perform representation aggregation on nodes corresponding to N target users in a user relationship network graph by using the graph neural network, to obtain user representations of the N target users;
a first determining module, configured to determine a predicted loss corresponding to each target user based on at least a user representation of each target user by using a predetermined loss function related to a target service;
a second determining module, configured to determine a weight value corresponding to each target user based on each predicted loss, so that a larger predicted loss indicates a larger weight value of a corresponding target user;
a third determining module, configured to determine a total predicted loss based on the predicted loss and the weight value of each target user; and
an adjustment module, configured to adjust parameters of the graph neural network with an objective of minimizing the total predicted loss.

According to a third aspect, a computer-readable storage medium is provided. The computer-readable storage medium stores a computer program. When the computer program is executed in a computer, the computer is enabled to perform the method according to the first aspect.

According to a fourth aspect, a computing device is provided. The computing device includes a memory and a processor. The memory stores executable code. When executing the executable code, the processor implements the method according to the first aspect.

According to the methods and the apparatuses provided in the embodiments of this specification, the user relationship network graph using users as nodes is processed by using the graph neural network, to obtain the user representations of the N target users in the user relationship network graph. Then the predicted loss corresponding to each target user is determined based on at least the user representation of each target user by using the predetermined loss function related to the target service. Then, considering fairness to a vulnerable group, in a process of training a network model, it is insufficient to pay attention only to a mainstream group, and performance of the network model on the vulnerable group needs to be reliably ensured. Correspondingly, the weight value corresponding to each target user is determined based on each predicted loss, so that a larger predicted loss indicates a larger weight value of a corresponding target user. Then the total predicted loss is determined based on the predicted loss and the weight value of each target user. The parameters of the graph neural network are adjusted with the objective of minimizing the total predicted loss. In the above-mentioned process, a larger predicted loss indicates a larger weight value of a corresponding target user, so that a degree of attention to a target user (theoretically belonging to the vulnerable group) with a relatively large predicted loss in the process of training the network model can be increased, thereby improving fairness of the graph neural network to the vulnerable group. In addition, in the training process, there is no need to know privacy data of each target user in advance, and the graph neural network is trained by leveraging the idea of distributionally robust optimization, so that representation aggregation performance of the graph neural network on the vulnerable group (the target user with a large predicted loss) is ensured, thereby protecting privacy data of the user and ensuring fairness to the vulnerable group.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram illustrating an implementation framework of one or more embodiments disclosed in this specification;

FIG. 2 is a schematic flowchart illustrating a training method for a graph neural network considering privacy protection and fairness, according to one or more embodiments:

FIG. 3 is a schematic diagram illustrating a user relationship network graph, according to one or more embodiments; and

FIG. 4 is a schematic block diagram illustrating a training apparatus for a graph neural network considering privacy protection and fairness, according to one or more embodiments.

### DESCRIPTION OF EMBODIMENTS

The following describes in detail the technical solutions in the embodiments of this specification with reference to the accompanying drawings.

The embodiments of this specification disclose training methods and apparatuses for a graph neural network considering privacy protection and fairness. The following first describes an application scenario and a technical concept of the training method for a graph neural network considering privacy protection and fairness. Details are as follows:

As described above, in some of methods for solving a fairness problem of a machine learning model (for example, a graph neural network), some attribute features (for example, gender and age) of a person need to be considered, to train a graph neural network (namely, a fair graph neural network) that has fairness for these attribute features. These attribute features are usually characterized by privacy, and are prone to cause leakage of privacy data of the person.

In view of this, the inventor proposes a training method for a graph neural network considering privacy protection and fairness. First, it is worthwhile to note that the training method provided in the embodiments of this specification mainly focuses on Rawlsian Max-Min fairness. To be specific, in a process of training a network model, it is insufficient to pay attention only to performance of the network model on a mainstream group (a group of users accounting for a relatively large proportion), and performance of the network model on a vulnerable group (a group of users accounting for a relatively small proportion) also needs to be ensured, in other words, the vulnerable group needs to be protected.

For example, in a subsequent social network scenario shown in FIG. 3, users performing infrequent interactions can be considered as a vulnerable group in a user relationship network graph in the social network scenario. For another example, in a user relationship network graph of an e-commerce platform (or an e-payment platform), if a proportion of users whose ages exceed a first age threshold is less than a predetermined proportion threshold, it can be considered that a group of the users whose ages exceed the first age threshold is a vulnerable group in the user relationship network graph.

It can be understood that the vulnerable group is a group with a relatively low proportion, and can be embodied as a subset with a relatively low proportion in a sample set needed for network model training. For example, in a process of training a network model for performing classification analysis on users, if a proportion of samples of a group of users whose ages exceed a predetermined value is relatively low, the user group can be referred to as a vulnerable group. In some implementations, in a process of training a network model that does not consider fairness, an average error of samples in a user sample set is usually optimized to optimize training of the network model. However, in this process, a feature representation of a vulnerable group is easily ignored. Consequently, the feature representation of the vulnerable group is overshadowed by a mainstream group in the process of optimizing training of the network model, and then performance of the network model on the vulnerable group is poor. Correspondingly, poor performance of the network model on the vulnerable group can be reflected as an inaccurate prediction result of the network model for the vulnerable group and a relatively large predicted loss of the network model for the vulnerable group in the process of training the network model.

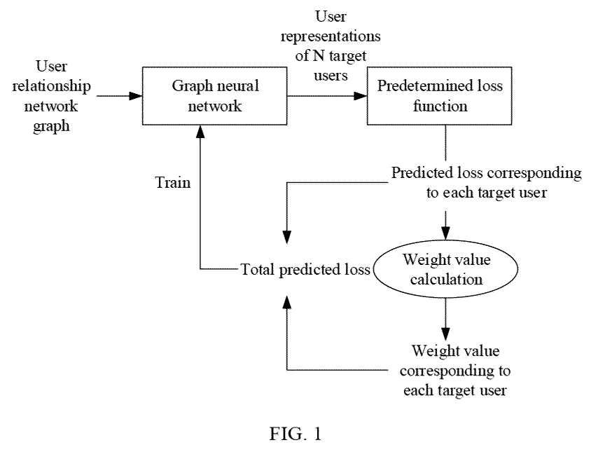

On the basis of the above-mentioned descriptions, to improve the performance of the graph neural network on the vulnerable group and implement fair processing on the vulnerable group, in the process of training the network model, more attention needs to be paid to the vulnerable group, and attention needs to be paid to privacy protection of a user group. Correspondingly, FIG. 1 is a schematic diagram illustrating a training scenario of a graph neural network considering privacy protection and fairness, according to one or more embodiments. In the schematic diagram illustrating the scenario, specifically, a user relationship network graph using users as nodes is first obtained. An edge in the user relationship network graph represents a direct association relationship between the users. The association relationship can be, for example, a social relationship, a transaction relationship, or a transfer relationship. Representation aggregation is performed on nodes corresponding to N target users in the user relationship network graph by using the graph neural network, to obtain user representations of the N target users. A predicted loss corresponding to each target user is determined based on at least a user representation of each target user by using a predetermined loss function related to a target service.

Then, to increase attention of the graph neural network to a vulnerable group and implement protection for the vulnerable group, correspondingly, a weight value corresponding to each target user can be determined based on the predicted loss corresponding to each target user, so that a larger predicted loss indicates a larger weight value of a corresponding target user. It can be understood that with reference to the above-mentioned description that a network model that does not consider fairness has poor performance on a vulnerable group, which can be reflected as a relatively large predicted loss of the network model for the vulnerable group in a process of training the network model, in view of this, attention of the graph neural network to the vulnerable group (a target user with a large predicted loss) can be increased by setting a weight value. Specifically, a larger predicted loss indicates a larger weight value of a corresponding target user and a larger degree of attention to the corresponding target user. In addition, in a training process, there is no need to know in advance which users in the user relationship network graph are in a vulnerable group, in other words, there is no need to know privacy data of a user group in advance. Instead, a target user belonging to the vulnerable group is estimated based on performance of the graph neural network on a target user in a target service task in the training process. A larger predicted loss indicates a larger possibility that a corresponding target user belongs to the vulnerable group and more corresponding attention needed for such type of target user, that is, a larger weight value of the target user. In the above-mentioned method, a degree of attention of the graph neural network to the vulnerable group in the target service task can be increased, so that a capability of protecting the vulnerable group by the graph neural network in the target service task can be improved in the training process, and privacy data of the user group can be protected.

Then a total predicted loss is determined based on the predicted loss and the weight value of each target user. Specifically, the sum of products of the predicted losses and weight values of the target users can be calculated, and the sum can be determined as the total predicted loss. Then parameters of the graph neural network are adjusted with an objective of minimizing the total predicted loss.

In the above-mentioned process, a larger predicted loss indicates a larger weight value of a corresponding target user, so that a degree of attention to a target user (theoretically belonging to the vulnerable group) with a relatively large predicted loss in the process of training the graph neural network can be increased, thereby improving fairness of the graph neural network to the vulnerable group. In addition, in the training process, there is no need to know privacy data of each target user in advance, and a worst-case distribution of the weight values of the predicted losses corresponding to the target users is constructed based on the idea of distributionally robust optimization, to obtain an optimal solution in the case of the worst-case distribution. In other words, the graph neural network is trained with the objective of minimizing the total predicted loss, to ensure representation aggregation performance of the graph neural network on the vulnerable group (the target user with a large predicted loss), thereby protecting privacy data of the user and ensuring fairness to the vulnerable group.

With reference to specific embodiments, the following describes in detail a training method and apparatus for a graph neural network considering privacy protection and fairness that are provided in this specification.

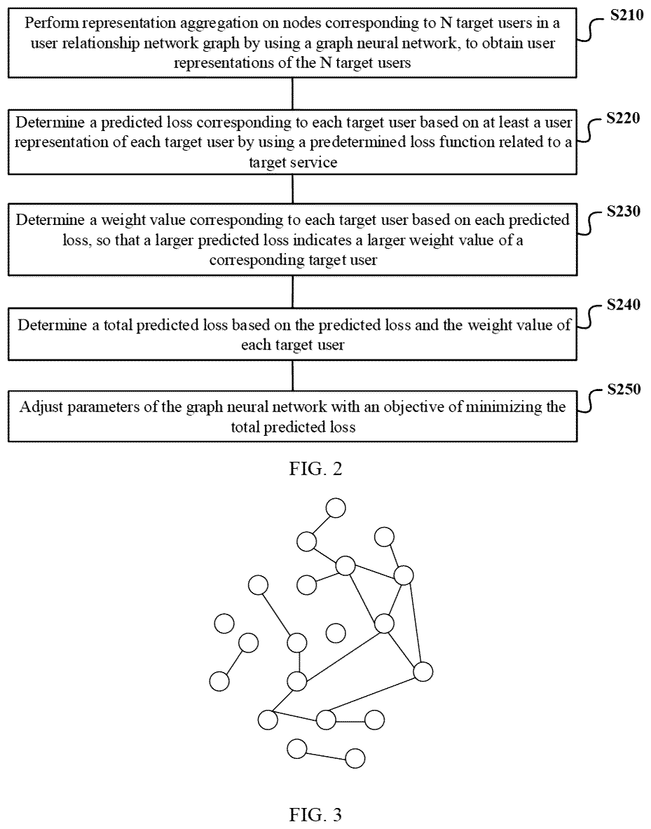

FIG. 2 is a flowchart illustrating a training method for a graph neural network considering privacy protection and fairness, according to one or more embodiments of this specification. The method can be implemented by any apparatus, device, platform, device cluster, etc. having computing and processing capabilities. In a training process, as shown in FIG. 2, the method includes the following step S210 to step S250.

First, in step S210, representation aggregation is performed on nodes corresponding to N target users in a user relationship network graph by using the graph neural network, to obtain user representations of the N target users. In this step, the user relationship network graph can be constructed for users of a target platform and an association relationship between the users. Each node corresponds to each user of the target platform, and an edge represents an association relationship between the users. In a case, the target platform can be, for example, an e-commerce platform, an e-payment platform, a financial platform, or a social platform. In an example, when the target platform is the e-commerce platform, each node in the user relationship network graph corresponds to each user of the e-commerce platform, and the association relationship represented by the edge can be a transaction relationship between the users of the e-commerce platform. In another example, when the target platform is the e-payment platform (or the financial platform), each node in the user relationship network graph corresponds to each user of the e-payment platform, and the association relationship represented by the edge can be a transfer relationship (or a debit/credit relationship) between the users of the e-payment platform. In still another example, when the target platform is the social platform, each node in the user relationship network graph corresponds to each user of the social platform, and the association relationship represented by the edge can be a social interaction relationship between the users of the social platform.

In step S210, the N target users can be randomly determined from the user relationship network graph based on a service need of a target service. In a case, when the target service is a classification service (for example, user classification prediction) or a regression service (user metric value prediction), each target user is a user having label data corresponding to the target service. In another case, when the target service is an autoencoding service, the target user can be any user in the user relationship network graph.

After the N target users are determined, in one or more embodiments, the user relationship network graph can be input to the graph neural network, and K-level representation aggregation can be separately performed on the nodes corresponding to the N target users in the user relationship network graph based on at least sets of K-hop neighboring nodes corresponding to the N target users by using K aggregation layers of the graph neural network, to obtain the user representations of the N target users. Both N and K are predetermined values. To obtain a graph neural network with better performance through training larger N is preferred. K can be set based on actual needs (for example, the quantity of aggregation layers of the graph neural network), for example, set to 2. The user representation of the target user can aggregate feature data of the target user and feature data of each node in the set of K-hop neighboring nodes of the target user.

Considering that an overall data volume of the user relationship network graph is relatively large, to reduce computing resource consumption, in one or more other embodiments, step S210 can include: in the user relationship network graph, determining, by using a node corresponding to each target user as a central node, a set of K-hop neighboring nodes of the central node, where the central node and the set of K-hop neighboring nodes of the central node form a sample subgraph; and inputting each sample subgraph to the graph neural network, and performing representation aggregation on a central node in the sample subgraph. Each sample subgraph includes a central node, a set of K-hop neighboring nodes of the central node, and an edge between the nodes. After each sample subgraph is input to the graph neural network, K-level aggregation can be performed on a central node in the sample subgraph based on feature data of nodes in the sample subgraph by using the K aggregation layers of the graph neural network. In an implementation, a sampling process of the sample subgraph can be implemented by using an AGL system.

In a case, a relatively small quantity of users may be associated with the target user. For example, in the social network scenario, some users perform infrequent interactions, and a partial schematic diagram illustrating a user relationship network graph of the users performing infrequent interactions can be shown in FIG. 3. A node corresponding to the user performing infrequent interactions is relatively isolated, and usually exists in a relatively special subgraph. For example, the quantity of nodes in the subgraph including the node corresponding to the user performing infrequent interactions is relatively small (for example, is less than a predetermined quantity, is 3, or has no neighboring node). Correspondingly, if such type of user (for example, a user without a neighbor) is determined as a target user, a sample subgraph of the user can include only a node corresponding to the target user.

After the user representations of the N target users are obtained through aggregation, in step S220, a predicted loss corresponding to each target user is determined based on at least a user representation of each target user by using a predetermined loss function related to the target service.

In one or more embodiments, the target service can be a user classification prediction service, a user metric value prediction service, or an autoencoding service, and different target services can correspond to different predetermined loss functions. For example, when the target service is the user classification prediction service, the predetermined loss function can be a cross-entropy loss function. When the target service is the user metric value prediction service, the predetermined loss function can be a mean squared error (MSE) loss function. When the target service is the autoencoding service, the predetermined loss function can be a loss function used to construct a feature reconstruction loss in an unsupervised task.

In one or more embodiments, when the target service is the user classification prediction service or the user metric value prediction service, each target user has label data corresponding to the target service. Correspondingly, step S220 can specifically include: processing the user representation of each target user by using a prediction network related to the target service, to obtain a prediction result corresponding to each target user; and inputting the label data and the prediction result to the predetermined loss function to obtain the corresponding predicted loss. When the target service is the user classification prediction service, the prediction network is a user classification network. When the target service is the user metric value prediction service, the prediction network is a user metric prediction network.

Specifically, after the user representations of the N target users are obtained, the user representation of each target user is input to the prediction network, the user representation of each target user is processed by using the prediction network, to obtain the prediction result corresponding to each target user, and the label data and the prediction result corresponding to each target user are input to the predetermined loss function, to obtain the predicted loss corresponding to each target user.

In one or more other embodiments, when the target service is the autoencoding service, step S220 can specifically include: processing the user representation of each target user by using a decoding network related to the target service, to determine reconstructed feature data of each target user; and calculating the predicted loss of each target user based on the reconstructed feature data of each target user and original feature data corresponding to each target user by using the predetermined loss function. In this step, the user representation of each target user is input to the decoding network, so that the user representation of each target user can be processed by using the decoding network, to obtain the reconstructed feature data of each target user. Then the predicted loss of each target user is calculated based on the reconstructed feature data of each target user and the original feature data corresponding to each target user by using the predetermined loss function. Specifically, a feature difference between the reconstructed feature data and the original feature data of each target user can be calculated, and the predicted loss of each target user can be determined based on the feature difference corresponding to each target user. In an implementation, the original feature data can include basic attribute data of a corresponding target user and feature data related to an association relationship.

It should be understood that the method provided in the embodiments of this specification mainly focuses on Rawlsian Max-Min fairness. To be specific, in a process of training a network model, it is insufficient to pay attention only to performance of the network model on a mainstream group (a group of users accounting for a relatively large proportion), and performance of the network model on a vulnerable group (a group of users accounting for a relatively small proportion) also needs to be ensured, in other words, the vulnerable group needs to be protected.

Therefore, by leveraging the idea of distributionally robust optimization, it is considered that distribution drift exists in the predicted losses (that is, the target users) corresponding to the target users. Then weight values are assigned to the predicted losses (that is, weight assignment), so that the predicted losses obtained after weight assignment form a worst-case data distribution (to be specific, a larger predicted loss indicates a larger weight value of a corresponding target user, and the sum of products of the predicted losses and corresponding weight values is the maximum). Then the graph neural network is trained for the worst-case data distribution with a training objective that the graph neural network has optimal performance in the case of the worst-case data distribution formed by the predicted losses obtained after weight assignment. As such, a graph neural network that can protect the vulnerable group (in other words, implement fairness) is obtained through training without the need to know privacy data of the user group in advance (in other words, attention to privacy protection is paid).

Specifically, in step S230, a weight value corresponding to each target user is determined based on each predicted loss, so that a larger predicted loss indicates a larger weight value of a corresponding target user. It can be understood that the predicted loss corresponding to each target user can indicate a representation capability (namely, performance) of the graph neural network on a target user in a target service task to a certain extent. If a predicted loss corresponding to the target user is larger, it can be considered that performance of the graph neural network on the target user in the target service task is poorer. A larger weight value is assigned to a target user (that is, the vulnerable group) with a larger predicted loss, so that the graph neural network pays more attention to such type of target user, thereby improving fairness of the graph neural network to such type of user (the vulnerable group) and improving performance on the vulnerable group in the target service task.

The weight value corresponding to each target user falls within a range of [0, 1), and the sum of weight values corresponding to the target users is 1. In a case, when a predicted loss corresponding to a target user is less than a predetermined loss value, a weight value corresponding to the target user can be set to 0.

In one or more embodiments, step S230 can specifically include: determining each weight value under a predetermined constraint with an objective of maximizing the sum of the products of the predicted losses and the weight values corresponding to the predicted losses, where the predetermined constraint includes that a distance between an actual distribution formed by the weight values and a predetermined prior distribution does not exceed a perturbation radius. The distance can be an F-divergence distance, a Wasserstein distance, or a CVaR value between the actual distribution formed by the weight values and the predetermined prior distribution. In an implementation, the predetermined prior distribution can be a uniform distribution.

The following formula can be used to represent a process of determining the weight value of each target user:

$${Q}^{*} = arg ma \{ {\sum }_{i = 1}^{N} {q}_{i} l ( θ ; {X}_{i} ) \} ,$$

Q represents the actual distribution formed by the weight values of the target users, [symbol] represents the predetermined prior distribution, ρ represents the perturbation radius, D_{fk} (Q| [symbol] )≤ρ represents that the F-divergence distance between the actual distribution and the predetermined prior distribution does not exceed (is less than or equal to) the perturbation radius, qᵢ represents a weight value of an i^{th} target user, and l(θ;Xᵢ) represents a predicted loss of the i^{th} target user, where Xᵢ; represents original feature data of the i^{th} target user, and θ represents parameters of the graph neural network (as well as the prediction network or the decoding network). Therefore, a result obtained through summation is the sum of the products of the predicted losses of the target users and the weight values corresponding to the predicted losses. Q* represents an obtained optimal actual distribution formed by the weight values of the target users, that is, the sum of the products reaches the maximum.

The maximum sum of the products of the predicted losses and the weight values corresponding to the predicted losses corresponds to the worst-case data distribution of the predicted losses obtained after weight assignment in the case of distribution drift. Correspondingly, the graph neural network (as well as the prediction network or the decoding network) pays more attention to performance (worst-case performance) in the case of the worst-case data distribution, to implement robustness in the case of distribution drift. As such, fairness and privacy protection performance of the graph neural network can be improved, and tail performance of the graph neural network (as well as the prediction network or the decoding network) can also be improved.

In one or more embodiments, the perturbation radius is determined based on a predetermined proportion of vulnerable-group users in the user relationship network graph. In an implementation, the predetermined proportion α of the vulnerable-group users in the user relationship network graph can fall within a range of (0, 0.5). In a case, α can fall within [0.1, 0.3]. In an implementation, the perturbation radius ρ can be determined by using the following formula, where the perturbation radius is ρ=(1/α−1)².

After the weight value of each target user is determined, in step S240, a total predicted loss is determined based on the predicted loss and the weight value of each target user. In one or more embodiments, step S240 can specifically include: calculating the sum of the products of the predicted losses of the target users and the corresponding weight values, and using the sum as the total predicted loss. As such, the calculated total predicted loss can enable more attention to be paid to the vulnerable group (that is, the target user with a large predicted loss). Then, in step S250, the parameters of the graph neural network are adjusted with an objective of minimizing the total predicted loss. In this step, a parameter gradient of the graph neural network is determined based on the total predicted loss by using a backpropagation algorithm. Updated values of the parameters of the graph neural network are determined by using the determined model parameter gradient and current values of the parameters of the graph neural network. Further, the parameters of the graph neural network are adjusted based on the updated values. The parameter gradient of the graph neural network is determined with the objective of minimizing the total predicted loss.

In one or more embodiments, when the target service is the user classification prediction service or the user metric value prediction service, the prediction network (a user classification network or a user metric value prediction network) related to the target service is further connected after the graph neural network. Step S250 can specifically include: adjusting parameters of the graph neural network and the prediction network with the objective of minimizing the total predicted loss.

In one or more other embodiments, when the target service is the autoencoding service, the decoding network related to the target service is further connected after the graph neural network (namely, an encoding network), and is configured to decode the user representation of each target user to obtain the reconstructed feature data of each target user. Correspondingly, step S250 can further specifically include: adjusting parameters of the graph neural network and the decoding network with the objective of minimizing the total predicted loss.

Step S210 to step S250 are one iterative training process. To obtain a better graph neural network (and a better prediction network or decoding network related to the target service) through training, the above-mentioned process can be repeatedly performed. To be specific, after step S250, step S210 is performed based on the updated values of the parameters of the graph neural network (and the prediction network or the decoding network related to the target service). A stop condition for the iterative training process can include that an iterative training count reaches a predetermined count threshold, or iterative training duration reaches predetermined duration, or the total predicted loss is less than a predetermined loss threshold, etc.

In the embodiments, a larger predicted loss indicates a larger weight value of a corresponding target user, so that a degree of attention to the target user (theoretically belonging to the vulnerable group) with a relatively large predicted loss in the process of training the graph neural network can be increased, thereby improving fairness of the graph neural network to the vulnerable group. In addition, in the training process, there is no need to know privacy data of each target user in advance, and the worst-case distribution of the weight values of the predicted losses corresponding to the target users is constructed based on the idea of distributionally robust optimization, to obtain an optimal solution in the case of the worst-case distribution. In other words, the graph neural network is trained with the objective of minimizing the total predicted loss, to ensure representation aggregation performance of the graph neural network on the vulnerable group (the target user with a large predicted loss), thereby protecting privacy data of the user and ensuring fairness to the vulnerable group.

In addition, in the embodiments, it can be considered that in the process of training the graph neural network model, a calculation unit for calculating a distributionally robust optimization (DRO) weight value is embedded in a loosely coupled form in a process of calculating the total predicted loss, so that a graph neural network obtained through training considers privacy protection and fairness.

The embodiments can implement training of a graph neural network considering privacy protection and fairness on an industrial-scale large graph, and can be used in graph learning practice of trustworthy AI.

The weight values corresponding to the target users are determined with the objective of maximizing the sum of the products of the predicted losses and the weight values corresponding to the predicted losses, to obtain the worst-case data distribution of the predicted losses obtained after weight assignment. Then the graph neural network (as well as the prediction network or the decoding network) is trained with the objective of minimizing the total predicted loss (the sum of the products of the predicted losses and the weight values corresponding to the predicted losses), to obtain the graph neural network through training. As such, the optimal solution in the case of the worst-case data distribution is obtained, and correspondingly, and robustness of the graph neural network in the case of the worst-case data distribution can be ensured, in other words, the performance of the graph neural network on the vulnerable group can be ensured. In the user relationship network graph with the vulnerable group, the graph neural network can have good privacy protection and fairness performance.

The above-mentioned content describes specific embodiments of this specification, and other embodiments fall within the scope of the appended claims. In some cases, the actions or steps described in the claims can be performed in a sequence different from that in the embodiments and desired results can still be achieved. In addition, the process depicted in the accompanying drawings does not necessarily need a particular sequence or a sequential sequence to achieve the desired results. In some implementations, multitasking and parallel processing are possible or may be advantageous.

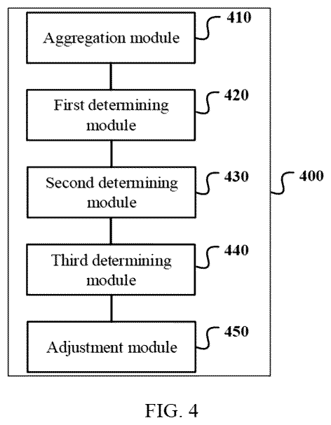

Corresponding to the above-mentioned method embodiments, one or more embodiments of this specification provide a training apparatus 400 for a graph neural network considering privacy protection and fairness. A schematic block diagram illustrating the training apparatus is shown in FIG. 4, and the training apparatus includes:
an aggregation module 410, configured to perform representation aggregation on nodes corresponding to N target users in a user relationship network graph by using the graph neural network, to obtain user representations of the N target users;
a first determining module 420, configured to determine a predicted loss corresponding to each target user based on at least a user representation of each target user by using a predetermined loss function related to a target service;
a second determining module 430, configured to determine a weight value corresponding to each target user based on each predicted loss, so that a larger predicted loss indicates a larger weight value of a corresponding target user;
a third determining module 440, configured to determine a total predicted loss based on the predicted loss and the weight value of each target user; and
an adjustment module 450, configured to adjust parameters of the graph neural network with an objective of minimizing the total predicted loss.

In an optional implementation, each target user has label data corresponding to the target service.

The first determining module 420 is specifically configured to process the user representation of each target user by using a prediction network related to the target service, to obtain a prediction result corresponding to each target user; and
input the label data and the prediction result to the predetermined loss function to obtain the corresponding predicted loss.

In an optional implementation, the adjustment module 450 is specifically configured to adjust parameters of the graph neural network and the prediction network with the objective of minimizing the total predicted loss.

In an optional implementation, the first determining module 420 is specifically configured to process the user representation of each target user by using a decoding network related to the target service, to determine reconstructed feature data of each target user; and
calculate the predicted loss of each target user based on the reconstructed feature data of each target user and original feature data corresponding to each target user by using the predetermined loss function.

In an optional implementation, the target service is one of the following services: user classification prediction, user metric value prediction, or an autoencoding service.

In an optional implementation, the second determining module 430 is configured to determine each weight value under a predetermined constraint with an objective of maximizing the sum of products of the predicted losses and weight values corresponding to the predicted losses, where the predetermined constraint includes that a distance between an actual distribution formed by the weight values and a predetermined prior distribution does not exceed a perturbation radius.

In an optional implementation, the predetermined prior distribution is a uniform distribution.

In an optional implementation, the perturbation radius is determined based on a predetermined proportion of vulnerable-group users in the user relationship network graph.

In an optional implementation, the third determining module 440 is configured to calculate the sum of products of the predicted losses of the target users and corresponding weight values as the total predicted loss.

In an optional implementation, the aggregation module 410 is configured to: in the user relationship network graph, determine, by using a node corresponding to each target user as a central node, a set of K-hop neighboring nodes of the central node, where the central node and the set of K-hop neighboring nodes of the central node form a sample subgraph; and
input each sample subgraph to the graph neural network, and perform representation aggregation on a central node in the sample subgraph.

The apparatus embodiments correspond to the method embodiments. For specific descriptions, references can be made to the descriptions in the method embodiments. Details are omitted here for simplicity. The apparatus embodiments are obtained based on the corresponding method embodiments, and have the same technical effects as the corresponding method embodiments. For specific descriptions, references can be made to the corresponding method embodiments.

One or more embodiments of this specification further provide a computer-readable storage medium. The computer-readable storage medium stores a computer program. When the computer program is executed in a computer, the computer is enabled to perform the training method for a graph neural network considering privacy protection and fairness provided in this specification.

One or more embodiments of this specification further provide a computing device, including a memory and a processor. The memory stores executable code. When executing the executable code, the processor implements the training method for a graph neural network considering privacy protection and fairness provided in this specification.

The embodiments in this specification are described in a progressive way. For same or similar parts of the embodiments, mutual references can be made between the embodiments. Each embodiment focuses on a difference from other embodiments. In particular, the embodiments of the storage medium and the computing device are basically similar to the method embodiments, and therefore are described briefly. For related parts, references can be made to related descriptions in the method embodiments.

A person skilled in the art should be aware that in the above-mentioned one or more examples, functions described in the embodiments of this specification can be implemented by hardware, software, firmware, or any combination thereof. When being implemented by software, these functions can be stored in a computer-readable medium or transmitted as one or more instructions or code on a computer-readable medium.

The objectives, technical solutions, and beneficial effects of the embodiments of this specification are further described in detail in the description of embodiments described above. It should be understood that the above-mentioned descriptions are merely specific implementations of the embodiments of this specification, and are not intended to limit the protection scope of this specification. Any modification, equivalent replacement, improvement, etc. made based on the technical solutions in this specification shall fall within the protection scope of this specification.

1. A training method for a graph neural network considering privacy protection and fairness, comprising:
performing representation aggregation on nodes corresponding to N target users in a user relationship network graph by using the graph neural network, to obtain user representations of the N target users;
determining a predicted loss corresponding to each target user based on at least a user representation of each target user by using a predetermined loss function related to a target service, wherein the predicted loss is used to determine a probability that a corresponding target user belongs to a vulnerable group, and a larger predicted loss indicates a larger probability that the corresponding target user belongs to the vulnerable group;
determining a weight value corresponding to each target user based on each predicted loss, so that a larger predicted loss indicates a larger weight value of a corresponding target user;
determining a total predicted loss based on the predicted loss and the weight value of each target user; and
adjusting parameters of the graph neural network with an objective of minimizing the total predicted loss.

2. The method according to claim 1, wherein each target user has label data corresponding to the target service; and
determining the predicted loss corresponding to each target user comprises:
processing the user representation of each target user by using a prediction network related to the target service, to obtain a prediction result corresponding to each target user; and
inputting the label data and the prediction result to the predetermined loss function to obtain the corresponding predicted loss.

3. The method according to claim 2, wherein adjusting the parameters of the graph neural network comprises:
adjusting the parameters of the graph neural network and the prediction network with the objective of minimizing the total predicted loss.

4. The method according to claim 1, wherein determining the predicted loss corresponding to each target user comprises:
processing the user representation of each target user by using a decoding network related to the target service, to determine reconstructed feature data of each target user; and
calculating the predicted loss of each target user based on the reconstructed feature data of each target user and original feature data corresponding to each target user by using the predetermined loss function.

5. The method according to claim 1, wherein the target service is one of the following services: user classification prediction, user metric value prediction, or an autoencoding service.

6. The method according to claim 1, wherein determining the weight value corresponding to each target user comprises:
determining each weight value under a predetermined constraint with an objective of maximizing a sum of products of the predicted losses and weight values corresponding to the predicted losses, wherein the predetermined constraint comprises that a distance between an actual distribution formed by the weight values and a predetermined prior distribution does not exceed a perturbation radius.

7. The method according to claim 6, wherein the predetermined prior distribution is a uniform distribution.

8. The method according to claim 6, wherein the perturbation radius is determined based on a predetermined proportion of vulnerable-group users in the user relationship network graph.

9. The method according to claim 1, wherein determining the total predicted loss comprises:
calculating a sum of products of the predicted losses of the target users and corresponding weight values as the total predicted loss.

10. The method according to claim 1, wherein performing the representation aggregation on nodes corresponding to N target users in a user relationship network graph by using the graph neural network comprises:
in the user relationship network graph, determining, by using a node corresponding to each target user as a central node, a set of K-hop neighboring nodes of the central node, wherein the central node and the set of K-hop neighboring nodes of the central node form a sample subgraph; and
inputting each sample subgraph to the graph neural network, and performing the representation aggregation on a central node in the sample subgraph.

11. (canceled)

12. A computing device, comprising a memory and a processor, wherein the memory stores executable code, and when executing the executable code, the processor implements a training method for a graph neural network considering privacy protection and fairness, the method comprises:
performing representation aggregation on nodes corresponding to N target users in a user relationship network graph by using the graph neural network, to obtain user representations of the N target users;
determining a predicted loss corresponding to each target user based on at least a user representation of each target user by using a predetermined loss function related to a target service, wherein the predicted loss is used to determine a probability that a corresponding target user belongs to a vulnerable group, and a larger predicted loss indicates a larger probability that the corresponding target user belongs to the vulnerable group;
determining a weight value corresponding to each target user based on each predicted loss, so that a larger predicted loss indicates a larger weight value of a corresponding target user;
determining a total predicted loss based on the predicted loss and the weight value of each target user; and
adjusting parameters of the graph neural network with an objective of minimizing the total predicted loss.

13. The computing device according to claim 12, wherein each target user has label data corresponding to the target service; and
the computing device being caused to determine the predicted loss corresponding to each target user includes being caused to:
process the user representation of each target user by using a prediction network related to the target service, to obtain a prediction result corresponding to each target user; and
input the label data and the prediction result to the predetermined loss function to obtain the corresponding predicted loss.

14. The computing device according to claim 13, wherein the computing device being caused to adjust the parameters of the graph neural network includes being caused to:
adjust the parameters of the graph neural network and the prediction network with the objective of minimizing the total predicted loss.

15. The computing device according to claim 12, wherein the computing device being caused to determine the predicted loss corresponding to each target user includes being caused to:
process the user representation of each target user by using a decoding network related to the target service, to determine reconstructed feature data of each target user; and
calculate the predicted loss of each target user based on the reconstructed feature data of each target user and original feature data corresponding to each target user by using the predetermined loss function.

16. The computing device according to claim 12, wherein the target service is one of the following services: user classification prediction, user metric value prediction, or an autoencoding service.

17. The computing device according to claim 12, wherein the computing device being caused to determine the weight value corresponding to each target user includes being caused to:
determine each weight value under a predetermined constraint with an objective of maximizing a sum of products of the predicted losses and weight values corresponding to the predicted losses, wherein the predetermined constraint comprises that a distance between an actual distribution formed by the weight values and a predetermined prior distribution does not exceed a perturbation radius.

18. The computing device according to claim 17, wherein the predetermined prior distribution is a uniform distribution.

19. The computing device according to claim 17, wherein the perturbation radius is determined based on a predetermined proportion of vulnerable-group users in the user relationship network graph.

20. The computing device according to claim 12, wherein the computing device being caused to determine the total predicted loss includes being caused to:
calculate a sum of products of the predicted losses of the target users and corresponding weight values as the total predicted loss.

21. The computing device according to claim 12, wherein the computing device being caused to perform the representation aggregation on nodes corresponding to N target users in a user relationship network graph by using the graph neural network includes being caused to:
in the user relationship network graph, determine a set of K-hop neighboring nodes of the central node, by using a node corresponding to each target user as a central node, wherein the central node and the set of K-hop neighboring nodes of the central node form a sample subgraph; and
input each sample subgraph to the graph neural network, and performing the representation aggregation on a central node in the sample subgraph.
